(19) United States
(12) Patent Application Publication
(10) Pub. No.: US 2016/0219885 A1
(43) Pub. Date: Aug. 4, 2016

(54) ANTIMICROBIAL MATERIAL AND METHOD OF PRODUCING SAME

(71) Applicant: 2387819 ONTARIO INC., Kitchener (CA)

(72) Inventors: Gary Paul CLUTHE, Waterloo (CA); Terry GOULD, Temecula, CA (US)

(21) Appl. No.: 15/021,299

(22) PCT Filed: Sep. 12, 2014
(86) PCT No.: PCT/CA2014/050863

§ 371 Date: Mar. 11, 2016

Related U.S. Application Data
(60) Provisional application No. 61/877,334, filed on Sep. 13, 2013.

(51) Int. Cl. A01N 59/20; C08K 3/08; A01N 25/10

(52) U.S. Cl. CPC A01N 59/20; A01N 25/10; C08K 3/08

(57) ABSTRACT

The disclosure is directed at an antimicrobial material which is a mixture of a polymer and an antimicrobial metal whereby the antimicrobial metal comprises 50% to 90% by weight of the antimicrobial material. The disclosure is also directed to a method of preparing the antimicrobial material as well as the use of the antimicrobial material in manufacturing products such as medical products and baby products. The antimicrobial material can also be moulded into arms for chairs, hospital bed supports, keyboards, faucets, toilet sets, door knobs or hospital bed arms.

### CROSS-REFERENCE TO RELATED APPLICATIONS

This application claims the benefit of U.S. Provisional Application No. 61/877,334 filed Sep. 13, 2013, which is hereby incorporated by reference.

### FIELD

The present disclosure relates generally to materials for manufacturing products. More particularly, the present disclosure relates to an antimicrobial material for use in manufacturing products and a method of producing the antimicrobial material.

### BACKGROUND

In some environments, such as in hospitals or nursing homes, there is a desire or need for sterile working environments for the health and welfare of patients, visitors or staff. In these types of environments, the concern is that pathogens existing on work surfaces may be passed on to patients either through direct contact by patients or through its transmission from other humans who have touched the affected surface. As the prevalence of these germs or bacteria is quite high, there is a need to provide disinfected surfaces in order to reduce the likelihood that pathogens may affect the patients, some of whom may be in situations where minimal contamination may cause a serious health concern.

While these pathogens may be easily removed by continually cleaning or disinfecting surfaces of items within the working environment, there is a chance that a spot or area may be missed or not cleaned due to a lack of time or an individual rushing to complete the task. Also, as these pathogens are typically microscopic, even with regular cleaning, one would never fully know if the surface was completely devoid of pathogens.

Therefore, there is a desire to provide a novel antimicrobial material for using in manufacturing products and a method of producing same.

The above information is presented as background information only to assist with an understanding of the present disclosure. No determination has been made, and no assertion is made, as to whether any of the above might be applicable as prior art with regard to the present disclosure.

### SUMMARY

It is an object of the present disclosure to obviate or mitigate at least one disadvantage of current products which require regular cleaning by an individual in order to remain sterile.

In one aspect, there is provided an antimicrobial material which is a mix between a polymer and an antimicrobial metal such as, but not limited to copper, copper alloy, brass or bronze. The antimicrobial metal is preferably between 50% to 90% by weight of the entire antimicrobial material.

In another aspect, the antimicrobial material includes a blowing or foaming agent.

In yet another aspect, there is provided a method of producing an antimicrobial material which includes combining a polymer and an antimicrobial metal whereby the antimicrobial metal is about 50% to 90% by weight of the entire antimicrobial material.

Other aspects and features of the present disclosure will become apparent to those ordinarily skilled in the art upon review of the following description of specific embodiments in conjunction with the accompanying Figures.

### BRIEF DESCRIPTION OF THE DRAWINGS

Embodiments of the present disclosure will now be described, by way of example only, with reference to the attached Figures

FIG. 1 is a flowchart outlining a method of producing an antimicrobial material; and

FIG. 2 is a schematic diagram of an antimicrobial material.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of exemplary embodiments of the disclosure as defined by the claims and their equivalents. The following description includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used to enable a clear and consistent understanding of the disclosure. Accordingly, it should be apparent to those skilled in the art that the following description of exemplary embodiments of the present disclosure is provided for illustration purpose only and not for the purpose of limiting the disclosure.

Generally, the present disclosure provides an antimicrobial material and a method of producing the antimicrobial material. The antimicrobial material of the disclosure may lead to the production and/or manufacture of products which include inherent disinfectant properties. In order words, the products which are manufactured by the antimicrobial material of the disclosure may be seen as self-disinfecting. This may find special benefit in the field of medical products in which a sterile environment is typically required. However, it will be understood that the use of this antimicrobial material in the manufacture of other products is also contemplated where sterile product surfaces are beneficial such as in baby products.

In one example of product manufacture, the antimicrobial material may be injection-moulded or extruded to form the desire product.

In one embodiment, the antimicrobial material is a composition of a polymer and an antimicrobial metal whereby the antimicrobial metal is about 50% to about 90% by weight of the entire composition. More preferably the metal is between 50% and 70% by weight and most preferably, the antimicrobial metal is 62.5% by weight of the entire composition. In some embodiments where the antimicrobial metal is between about 85% to about 90% by weight, the antimicrobial material may also include a lubricant material.

In one embodiment of the disclosure, the antimicrobial material is effective against bacteria, such as, but not limited to, Methicillin-resistant Staphylococcus aureus (MRSA), Escherichia coli (E-Coli), salmonella or Clostridium difficile (C. difficile). Products made with the antimicrobial material of the disclosure may naturally disinfect the product without user intervention or need for a user to physically clean the product in order to sterilize the product, however, such actions may further improve the sterility of the surface of a product.

In another aspect of the disclosure, the antimicrobial material includes a foaming, or blowing, agent which allows the antimicrobial metal to be “pushed” to the surface of the antimicrobial material after it has been compounded into a pellet form or after the material, or composition, has been injection-moulded or extruded.

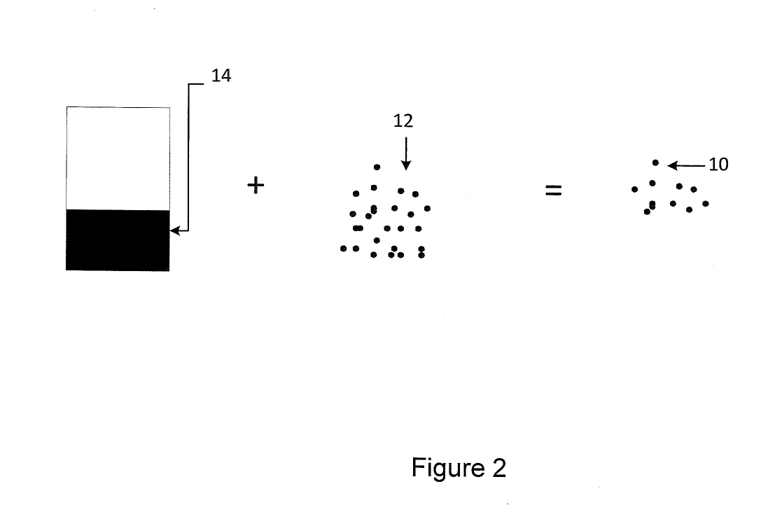

Turning to FIG. 2, a schematic diagram an antimicrobial material in pellet form is shown. As seen in FIG. 2, a pellet shell 10 (representing the antimicrobial material) is a combination of a polymer material 12 along with an antimicrobial metal 14. The antimicrobial metal is preferably 50% to 90% by weight of the antimicrobial material 14. Although shown in pellet form 10 (although not to scale), it will be understood that the antimicrobial material may also be in powdered form as long as it meets the 50% to 90% by weight requirement.

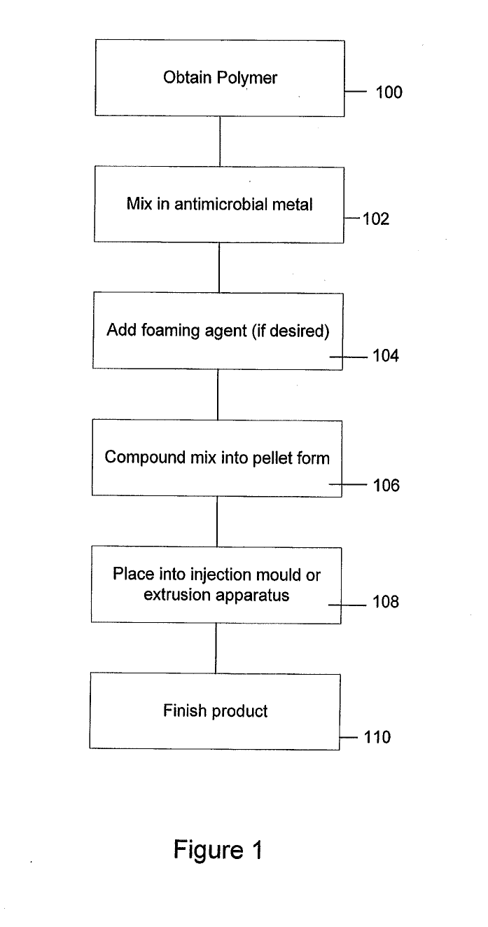

Turning to FIG. 1, a method of producing an antimicrobial material is shown. Firstly, a polymer material, such as, for example, a homopolymer or a co-polymer, is obtained 100. In a more specific example, the polymer material may be, but is not limited to, a polyester material, a polypropylene material, a polycarbonate material or an acrylonitrile butadiene styrene (ABS) material. The polymer material is preferably provided in a pellet form although a powdered polymer material may also be used.

After the polymer material is obtained, an antimicrobial metal, in powder form, is selected and added to the polymer material 102. The two material may be combined in any number of ways such as, but not limited to, twin extrusion. In the preferred embodiment, the antimicrobial metal is a metal that may be generally characterized as falling within the category of a metal which provides antimicrobial properties. More specifically, the antimicrobial metal may be, but is not limited to, brass, bronze, copper or any copper alloy.

In the antimicrobial material of the disclosure, the polymer material is used to provide strength, integrity and/or durability to the final composition while the antimicrobial metal may be seen as a filler material to the final composition, however, a filler material which provides self-disinfecting properties.

In one embodiment, the antimicrobial metal within the antimicrobial material is 50% to 90% by weight of the final composition. More preferably, the antimicrobial metal is 50% to 70% by weight and most preferably, the antimicrobial metal is 62.5% by weight of the final composition or in a 1.25:1 relationship with the polymer material.

In the embodiment of FIG. 2, where necessary, a further agent is added 104 to the to the polymer material and antimicrobial metal combination. For example, for a polymer material and antimicrobial metal combination in which the percentage by weight of the antimicrobial metal preferably remains within the range of 50% to 90%, a foaming agent may be added. The addition of the foaming agent causes the antimicrobial metal to move to the surface (such as when the antimicrobial material is in pellet form) or when the material is being injection-moulded or extruded. The foaming agent bubbles within the final composition (when heated) which causes the antimicrobial metal to move towards the surface. In another example in which the percentage by weight of the antimicrobial metal is between 85% and 90%, a lubricant agent may be added to the combination to assist in flow.

In another embodiment, an agent such as chromium may be added to the composition.

After the materials and, if added, the further agents, are combined or mixed together, they are compounded into a pellet form 106. While not necessary, it is preferred that the antimicrobial material is in a powder, in the form of individual pellets. Unlike known materials, the powder or pellets of the disclosure are homogenous in that there is an even distribution of antimicrobial metal throughout the mixture. This may also allow for products to be manufactured which have more esthetic angles without affecting the effectiveness of the antimicrobial metal or self-disinfecting capabilities.

By compounding the mixture into pellet form, this allows the antimicrobial material to be used in either an injection mould process or an extrusion apparatus 108 to form the final product into its desire shape and size.

After the finished product has been completed or taken out of the injection mould of extrusion apparatus, the product may be finished 110 such as by sandblasting, polishing, tumbling, sanding, buffering or any other known methods of polishing. It may be desired that the surface is polished to a high luster in order to provide a more aesthetic look to the finished product.

An advantage of the antimicrobial material of the disclosure over the use of a pure antimicrobial metal is that the antimicrobial material of the disclosure is lighter in weight, and allows for a better moldability in order to shape the final product. As examples, the antimicrobial material of the disclosure may be injection moulded into arms for chairs, hospital bed supports, keyboards, faucets, toilet seats, door knobs, hospital bed arms or any product which has a surface that is regularly touched and/or would benefit from having pathogens or bacteria be quickly removed or killed on the surface to reduce the likelihood of the pathogens being passed to a patient. In a preferred embodiment, the antimicrobial material is non-porous.

Another advantage of the antimicrobial material of the disclosure is that it provides a generally consistent antimicrobial agent rather than a coating or spray which may eventually erode as with some current solutions.

The antimicrobial or antibacterial properties of the antimicrobial metal of the disclosure may also protect the final product from bacterial degradation.

In one aspect of the disclosure, any items which are currently produced by copper or other metals may be replaced by items produced by the antimicrobial material of the disclosure.

A further advantage of the current disclosure is that while the antimicrobial material is plastic injection moldable, its looks or aesthetics make the material appear to be a cooper, copper alloy or aluminum.

The present description is provided by way of example. It will be apparent to persons skilled in the art that a number of variations and modifications can be made without departing from the scope of the claims

What is claimed is:

1. An antimicrobial material comprising:
a polymer material; and
an antimicrobial metal;
wherein the antimicrobial metal is between about 50% to about 90% by weight of the antimicrobial material.

2. The antimicrobial material of claim 1 wherein the antimicrobial metal is between 85 to 90% by weight of the antimicrobial material.

3. The antimicrobial material of claim 2 further comprising a lubricant.

4. The antimicrobial material of claim 1 wherein the antimicrobial material is non-porous.

5. The antimicrobial material of claim 1 wherein the antimicrobial metal is about 50% to about 70% by weight of the antimicrobial material.

6. The antimicrobial material of claim 5 wherein the antimicrobial metal is about 62.5% by weight of the antimicrobial material.

7. The antimicrobial material of claim 1 further comprising a foaming agent.

8. The antimicrobial material of claim 1 further comprising chromium.

9. The antimicrobial material of claim 1 wherein the polymer material is selected from a group consisting of a homopolymer, a co-polymer, a polyester, a polypropylene material, a polycarbonate material and an acrylonitrile butadiene styrene (ABS) material.

10. The antimicrobial material of claim 1 wherein the antimicrobial metal is selected from a group consisting of brass, bronze, copper and a copper alloy.

11. A method of producing an antimicrobial material comprising:
combining a polymer material with an antimicrobial metal to form an antimicrobial mixture wherein the antimicrobial metal is between about 50% to about 90% by weight of the antimicrobial material.

12. The method of claim 11 further comprising:
compounding the antimicrobial mixture into pellet form.

13. The method of claim 11 further comprising adding a foaming agent to the antimicrobial mixture if the antimicrobial metal is between about 50% and about 80% by weight of the antimicrobial material.

14. The method of claim 11 further comprising adding a lubricant agent to the antimicrobial mixture if the antimicrobial metal is between about 85% and about 90% by weight of the antimicrobial material.

15. The method of claim 11 further comprising adding chromium to the antimicrobial mixture.

16. The antimicrobial material of claim 1 wherein the material has an appearance like copper, a copper alloy or aluminum.
